(19) United States
(12) Patent Application Publication
(10) Pub. No.: US 2002/0121291 A1
(43) Pub. Date: Sep. 5, 2002

(54) Method and device to clean the interior room of a car

(76) Inventors: Wolfgang R.A. Daum, Groton, MA (US); Hans-Jochen Gunther, Rostock (DE)

Correspondence Address: BULLDOG MARKETING INC., 50 DUCK POND DRIVE, GROTON, MA, 01450, US

(21) Appl. No.: 10/068,660

(22) Filed: Feb. 8, 2002

(30) Foreign Application Priority Data
Mar. 3, 2001 (DE) 101 10 373.5-22

(51) Int. Cl. B60S 3/00

(52) U.S. Cl. 134/8; 134/22.1; 134/18; 134/21; 134/113; 134/123; 15/DIG. 2; 15/53.1

(57) ABSTRACT

A cleaning device and cleaning method to automatically clean the interior of a car. The devices having a robot arm and cleaning tools.

### FIELD OF THE INVENTION

The present invention relates to a method and a robotic device to clean the inner space of a car.

### BACKGROUND OF THE INVENTION

To maintain the care of cars a dense net of car wash service stops arose in particular in the industrialized countries of the world. The list of the offered services is most extremely extensive, and with number of the cars increasing continuously also these services become still stronger specializes and diversified.

Because of the high personnel costs, automatic car washing streets developed. Furthermore there are washing-stops, where in self-service the customer will get washing-utensils and cleaning tools to was his own car. This principle finds application especially for the primary treatment of the interior space of the car. Vacuum cleaners are set up for this purpose.

Automatic appliances to the interior cleaning of cars are known for example from U.S. Pat. No. 4,473,409 or EP 0,493,282. There a strong vacuum is connected by a soft suction hose onto a doorway of the vehicle through which the interior is evacuated. This procedure is not very efficient.

On the other hand the task of creating an appliance and a procedure for the cleaning of the interior of a car would be valuable to have. The task is to clean the different surface fields automatically.

### SUMMARY OF THE INVENTION

The here proposed cleaning appliance for the interior of a car is a robot arm with a cleaning tool as well as a programmable operation of the robot arm drive. With this appliance any cleaning tool can be introduced in the vehicle interior through the door or window opening. So cars of arbitrary types can be cleaned automatically, controlled by corresponding procedure programming considering model-particular topography or geometry dates. The model of the vehicle whose interior is supposed to be cleaned is identified by a picture identification system, which is part of the software.

The cleaning tool itself is interchangeable by an adapter mechanism. The cleaning procedure can be repeated, until for example depending on the degree of the pollution and the diversity of his surfaces the interior is cleaned with different or variously suitable cleaning tools. Hence, also surface fields that are not accessible through a vehicle door for the cleaning tool by means of the robot arm can be reached for example by a repetition of the procedural steps through another vehicle door in order to process all desired interior faces.

So by means of different cleaning tools and the an algorithm to select out of a step list the customer can select from different procedural cleaning zones:

the inner side of the windshield,

the inner side window,

the inner rear window,

the instrumentation panel,

the central console table,

the seats and back cushions,

the foot-spaces,

the door linings,

the door seals,

the roof sky,

the trunk,

Just to give examples here.

In order to reach the different interior fields of the various vehicle types the robot arm is arranged at a trolley appliance in the ceiling field of the cleaning-garage as a repeatedly flexibly driven arm, also sometimes called crab. The movable end of the robot arm with the preferably flexibly cleaning tool can reach to the cleaning site in the interior of the garage. Whether now in a garage or at another place: the cleaning site is combined with a preparation site (starting site) and a reworking site (ending site). There in each case—in a timesaving way according to the well-known assembly line principle—a car can be prepared already through opening openings such as doors or windows, while another car is already being cleaned there and while a third car is being prepared for departure. While clearing the vehicle at the preparation site the customer can remove objects laying in the car to a safe deposit box, which together with the vehicle will move to the exit site. There the objects are given back to the customer.

According to the shape and the material of the different interior surfaces as well as for example also according to the degree and the kind of the impurity the—preferably interchangeable—cleaning tool can comprise a wisp tool. In order to dissolve adhering dirt, the cleaning tool can have a spray-device for water or other cleaning agents. In order to bring out slackly particles from less accessible fields, the cleaning tool can have a jet for compressed air or a vapour-nozzle for the dissolution of dirt. In order to be able to supply the described cleaning tools with cleaning fluid, at least one utility-tube is led to the cleaning tool preferably through the robot arm and/or along the robot arm. This tube supplies compressed air and/or vapour and/or detergent-solution guide for example.

In order to remove solved or wiped dirt particles from the interior, the cleaning tool can have a sucking-nozzle, which can be supported by beating-action-appliances. The tubing for this disposal management is led preferably through the robot arm and/or along the robot arm to the outside.

The cleaning tool can comprise a brush that is capable to perform movements necessary to whip or shake off the dirt particles from the surface. In an other embodiment the brush can serve to limit and to canalise the dirt by being mounted around the suction opening of a corresponding appliance. The movement of the brush for the dissolution of the dirt particles can be controlled also through its own movement drive of the brush. For example the cleaning tool can have a brush guide rail, circular working brooms and/or a cylindrical working brush or any combination of these. The movement of the brushes can be lateral and/or rotationally. The driving force can come from an electrical motor, a pieco motor, an electro-magnetic swinging anchor, and pneumatics via a sucking- or blowing-air turbine or also by means of ultrasound source.

For the reliability in particular to avoid collisions of the cleaning tool the cleaning program of the invented procedure is provided with information about a number of car types. Topographical and geometrical information of existing car types stored in the system guarantee a collision-free movement of the cleaning tool and the robot arm. In addition sensors record the environment of the cleaning tool and the robot arm. Sensors will not only detect environmental changes of the interior of the car, compared to the stored data of the car type, but will also detect if for instance the car door to insert the robot arm is opened or closed. However, not only to avoid collisions, but for example also for the recognition of vehicle-individual characteristics sensors are used. For example in a van whose interior is just cleaned sensors might detect if certain sidewalls are mounted and if can change the procedure of cleaning those.

The soiling, removed from the interior of the car by any cleaning means can under circumstances contain also articles of value—for example money. In order to find and give back to the customers the value articles before disposing them, the soiling removed from the car will be presented to the customer on a riddle screen before disposal. The customer has the choice to remove then some idioms of value out of the soiling and dump the final rest to the trash. In order that the customer does not have to mess around in the trash the riddle screen device might have means of moving or shaking it.

The described invented cleaning process of a vehicle interior will be described in the following stages:

Step 1: On the “preparation site” all passengers leave the vehicle. Subjects from the seats, floor and any other compartments are removed and stored elsewhere outside the car. This outside storage can be mobile and move with the to be cleaned car and/or to be made as a safe deposit box.

Step 2: The customer drives up his vehicle to requested start position. The attaining of the correct position is signalled to the customer. The car can by a mechanical control system be guided through the machine on special lanes, or the machine moves around the car.

Step 3: An electronic monitoring system registers the precise vehicle position and vehicle geometry and car type by means of picture recognition of all sides, from above as well as from behind and in front. The motor vehicle type and the coordinates of the windows are defined. The coordinates are used to define the location of the cleaning zones. Alternatively, the car can carry a bar code like coding to be defined or simply the customer enters the exact car type by means of a keyboard or automatic identification card insertion into the system.

Step 4: The customer leaves (possibly on request through the system) his vehicle and begins with the preparation to the automatic cleaning.

All doors are being opened fully.

The trunk is opened (only if unloaded).

All persons are requested to leave the safety zone around the car of the cleaning site.

Start of the process by the customer with following single steps:

payment of cleaning fee,

selection of the cleaning program according to programmable cleaning zones, and

start of the process by confirming everything is clear.

Step 5: The opened doors are fixed pneumatically. The fixing is possible through inflatable pillows. This step can be avoided in one embodiment of the invention.

Step 6: Through picture recognition a further measurement of the vehicle is carried out with opened doors and opened trunk. With that information the system recognizes cleaning positions to be excluded (Doors in front, to the right and/or to the left; Doors behind, to the right and/or to the left of; Trunk). Corrections through the customer might require an interruption and repetition of the previous course possibly.

Step 7: The cleaning robot begins with the cleaning processing. An alternation of the cleaning applicators, when necessary, will be carried out.

Step 8: Cleaning course 1

The robot will clean one cleaning zone after the other. In this course the robot will clean one area after the other, e.g. the robot will first clean the drivers seat, then the drivers seat floor, then the front inner window. For this the robot will have to change the cleaning tools many times through the course of the cleaning zone.

Step 8: Cleaning course 2

The robot will clean with one cleaning tool after the other. In this course the robot use one cleaning tool, e.g. a certain brush, where ever needed in the car interior and then alternate to the next tool, e.g. a special wiper, etc. The robot arm in this course will move to the various cleaning zones many times.

Step 9: Picture or image recognition together with and remote tough sensing control the process of the cleaning robot. Obstacles that can not be assigned to the expected vehicle geometry lead the robot to avoid that particular zone. Objects in motion in the vehicle cause the robot to break off.

The remote sensing avoids collisions of the robot mechanism with the vehicle interior. A camera observes the vehicle and robot environment. Near objects in motion cause the robot to break off. The robot arm itself might comprise many tough sensors along its arm structure.

Step 10: The end of the cleaning job is signalled. The customer drives his vehicle to the “reworking area” . The safe deposit box is emptied. Subjects are admitted again into the vehicle, sucked off dirt is presented and it can be examined for valuables. Dirt is disposed finally.

Step 11: The customer leaves the cleaning facility.

Robot arms for this purpose can be any industrialized robot arm structure which has to be modified for this cleaning purpose.

### BRIEF DESCRIPTION OF THE DRAWINGS

One embodiment of the invention is described with the following figures:

FIG. 1 illustrates a three dimensional view of the invented cleaning apparatus.

FIG. 2 illustrates a cinematic model of the robot arm of FIG. 1.

FIG. 3 illustrates another spatial view of the robot arm with cleaning appliances of FIG. 1.

FIG. 4 illustrates a different robot arm with cleaning tool for robot of FIG. 1.

FIG. 5 illustrates a cleaning tool in three dimensions, partially cut opinion, of robot arm.

FIG. 6 illustrates a different spatial view, partially cut open of the cleaning tool.

FIG. 7 illustrates a three dimensional view of a cleaning appliance of robot arm.

FIG. 8 illustrates a different view of the appliance of FIG. 7.

FIG. 9 illustrates a three dimensional view of a cleaning tool.

FIG. 10 illustrates a different three-dimensional view of cleaning tool of FIG. 9.

FIG. 11 illustrates a three dimensional view, partially cut open, of a cleaning tool.

FIG. 12 illustrates another spatial view, partially cut open of cleaning tool of FIG. 11.

FIG. 13 illustrates a three dimensional view, partially cut open, of a cleaning tool.

FIG. 14 illustrates a three dimensional view of a robot arm with cleaning tool in accordance with FIG. 13.

FIG. 15 illustrates a further spatial view of a robot arm with the tool in accordance with FIG. 13 as well as with an inflatable shielding.

FIG. 16 illustrates a cinematic model of a robot arm of FIG. 4.

FIG. 17 illustrates a cinematic model of a robot arm.

FIG. 18 illustrates a cinematic model of a robot arm.

FIG. 19 illustrates a cinematic model of a robot arm.

FIG. 20 illustrates a cinematic model of a robot arm.

FIG. 21 illustrates the system with a watching camera and an image processing system.

### DETAILED DESCRIPTION OF THE PREFERRED EMBODIMENT

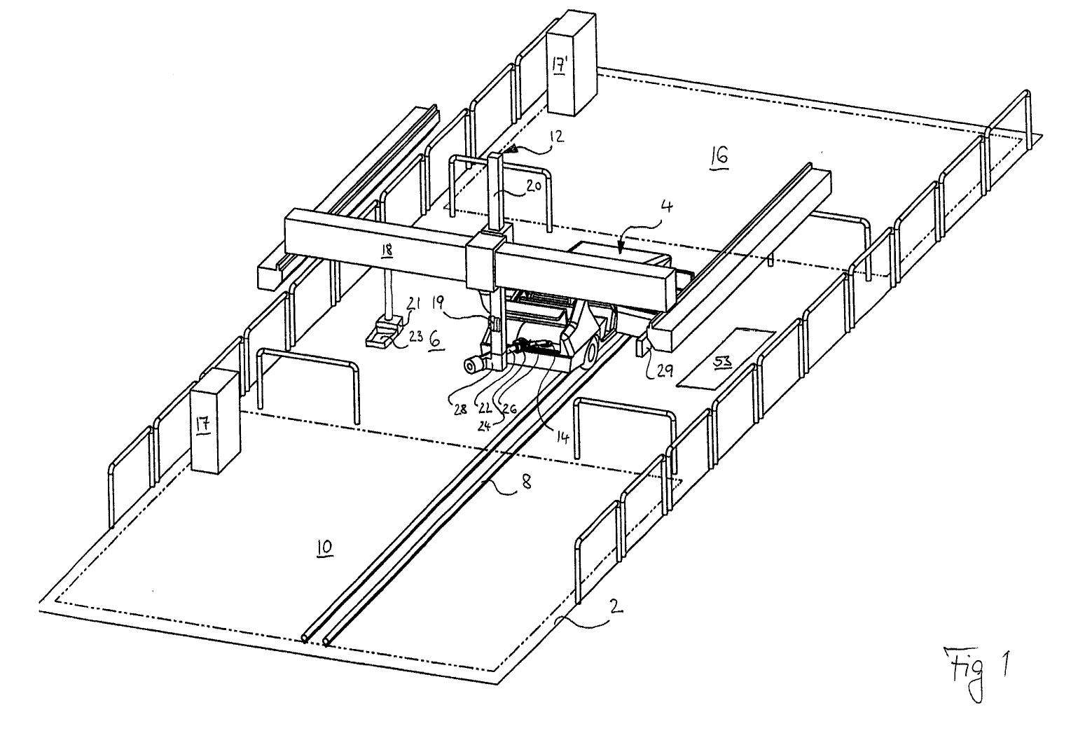

FIG. 1 illustrates the interior of a garage or any room designated for this robot with base 2. In the garage a car 4 stands at a cleaning site 6. The car 4 is guided by rails 8, in which the right front and rear wheels are guided, from the preparation site 10 to the cleaning site 6. After completion of the cleaning course of the cleaning process, which is carried out from a robot arm 12 with a cleaning tool 14, shown in this FIG. 1 in the trunk of the car 4, the car is automatically guided by tracks 8 to a reworking site 16. A safe deposit box 17 is recognizable at the preparation site 10. Stored personal belongings of the customer will be transported by a system, not shown here; to a position 17′ at the reworking site 16, where the customer gets back his belongings.

By means of the cleaning tool 14 soiling and dirt are sucked from the trunk of the car 4 and guided by a soft suction hose 19 which is attached to the robot arm 12 to the outside. A separator 21 made as a grid type device collects the larger particles of the sucked off dirt and presents these onto a presenting-grid 23, where the customer can take out any of the things he might want to keep.

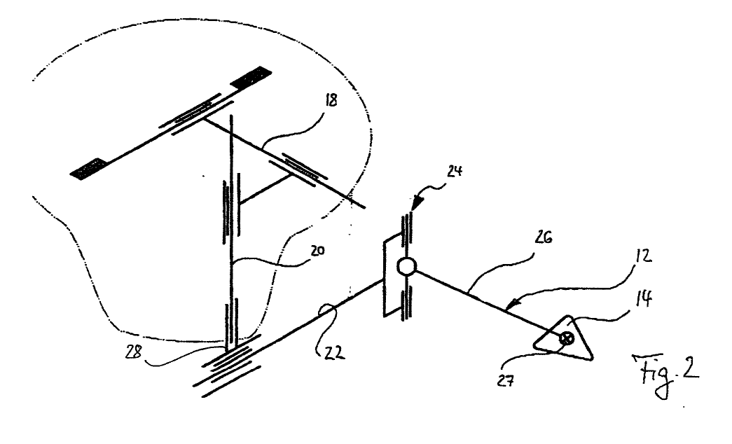

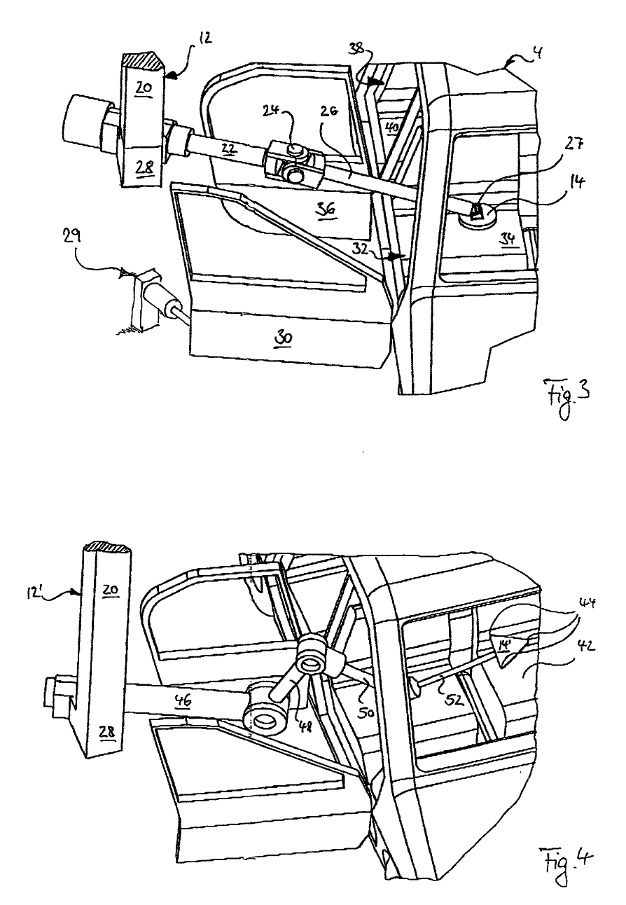

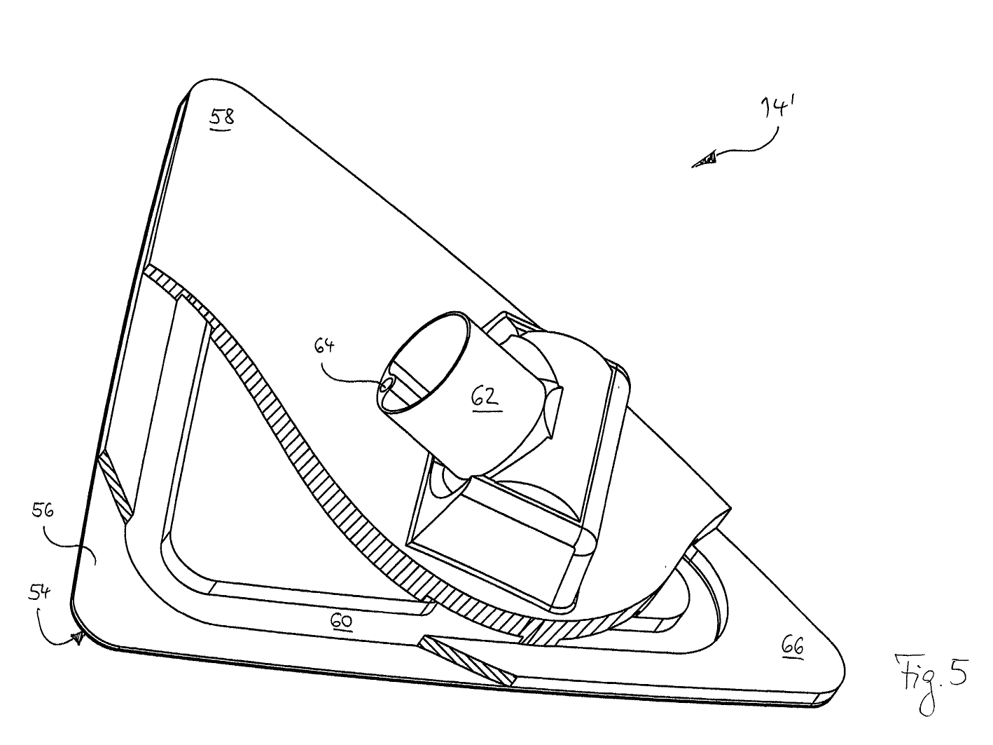

The cleaning tool 14 is moved by the robot arm 12 into the trunk of the car 4. The movement of the robot 12 makes therefore a relative movement between the cleaning tool 14 and (in the illustrated situation) the trunk bottom. In order to perform this movement in all most possible, better desirable, spatial directions (or spatial axes) in the field of the cleaning site 6, the robot arm comprises joints and other movable parts. This mobility and flexibility of the robot arm 12 is schematic illustrated in FIG. 2. FIG. 1 shows in an three dimensional view and FIG. 2 illustrates in a cinematic model that the robot arm 12 comprises a portal-arm-part 18 moving in horizontal way and an upright-arm 20 moving in a vertical way. At the lower end of the upright-arm 20 a forearm 22 is mounted. This forearm 22 is movable lateral along its longitudinal axis and can rotate around this axes. At the end of the forearm 22 a universal joint 24, which is turnable around two radial axes, is holding a girder 26 at which end the cleaning tool 14 is mounted. The cleaning tool 14 is attached by a Hooke's joint 27, which can rotate around two crossed axes; rotational degrees of freedom offset under 90° to each other. Hook's joints are sometimes called cardan or universal joints. Hence, and with the use of a ball-and-socket joint, the applied cleaning tool 14 is tiltable in two directions and will self-continuous arrange its orientation to the to be cleaned surface. This Hooke's joint 27 can be improved for this purpose by using elastic elements, such as metal, rubber or pneumatic springs. By pressing the cleaning tool 14 onto surface to be cleaned the active area of the cleaning tool 14 appears then automatically at said surface. In addition this Hooke's joint 27 can be twisted so that the direction of the three-angled wipe-surface 44 of the tool 14 for window polishing can be moved well into a corner of the windshield to be cleaned 42 (FIG. 4). The torsion of the girder 26 occurs in this case due to the torsion of the forearm 22 at the end of the upright girder 28 in accordance with FIG. 3. The torsion of the girder 52 in accordance with FIG. 4 occurs directly via the axial joint at the forearm 50.

The elements encircled with dots and dashes in FIG. 2, the portal 18 and the normal girder 20, can be moved (due to the described degrees of freedom) so that the lower end 28 and the upright girder 20, illustrated also in FIG. 3, can be moved round any arbitrary height of a car 4 around said car 4. This allows among other things also the position as illustrated in FIG. 3 in which the lower end 28 of the upright girder 20 is positioned next to the co-drivers door 30. Door 30 is kept open by the door holder 29. Through the so accessible doorway 32 the robot arm with cleaning tool 14 will clean the co-drivers seat 34. The cleaning tool 14 is guided from the described forearm 22 and girder 26 at the lower end 28 of the upright girder 20. On completion of the cleaning of the front seat 34 the rear right door 36 of the car 4 stands open to clean the back seat 40 of the car 4 through the doorway 38.

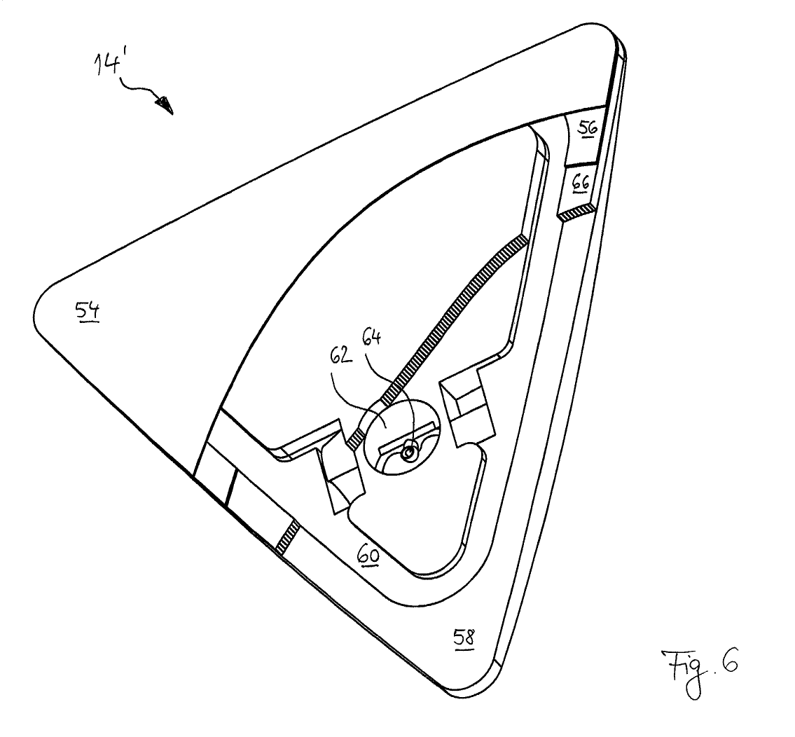

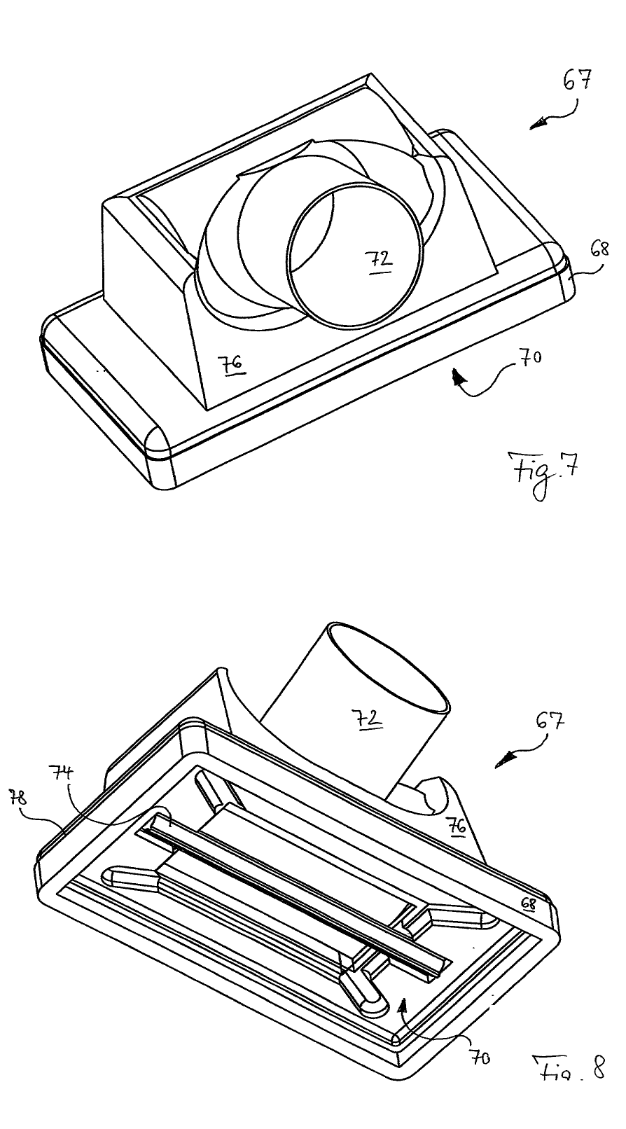

In FIG. 4 is shown a corresponding situation as in FIG. 3 but with a different robot arm 12′. The cleaning tool 14′ is a triangular wisp tool as described later with regard to FIGS. 5 and 6. In FIG. 4 the inner surface of the windshield 42 is cleaned. With its low-angular corners of the triangular wisp face 44 the cleaning tool 14′ in this case reaches the inner corners of the windshield 42 very efficient. This robot arm 12′ is mounted out of four straight sections, a shoulder 46, an upper arm 48, a forearm 50 and a girder 52. The shoulder 46 can be rotated around its longitudinal axis at the lower end 28 the upright girder 20, the upper arm 48 can rotate around a radial axis at the shoulder 46 angel lead, the forearm 50 can rotate around a radial axis at upper arm 48 and around its longitudinal axis. The girder 52 at the forearm 50 can rotate around a radial axis. Performing the wisp movement of the cleaning tool 14′ is caused from the robot arm 12′ in accordance with FIG. 4 by an accordion-like movement of upper arm 48 against forearm 50, while the wisp movement in accordance with FIG. 3 is performed through an axial longitudinal movement of the forearm 22 at the lower end 28 of the upright girder 20.

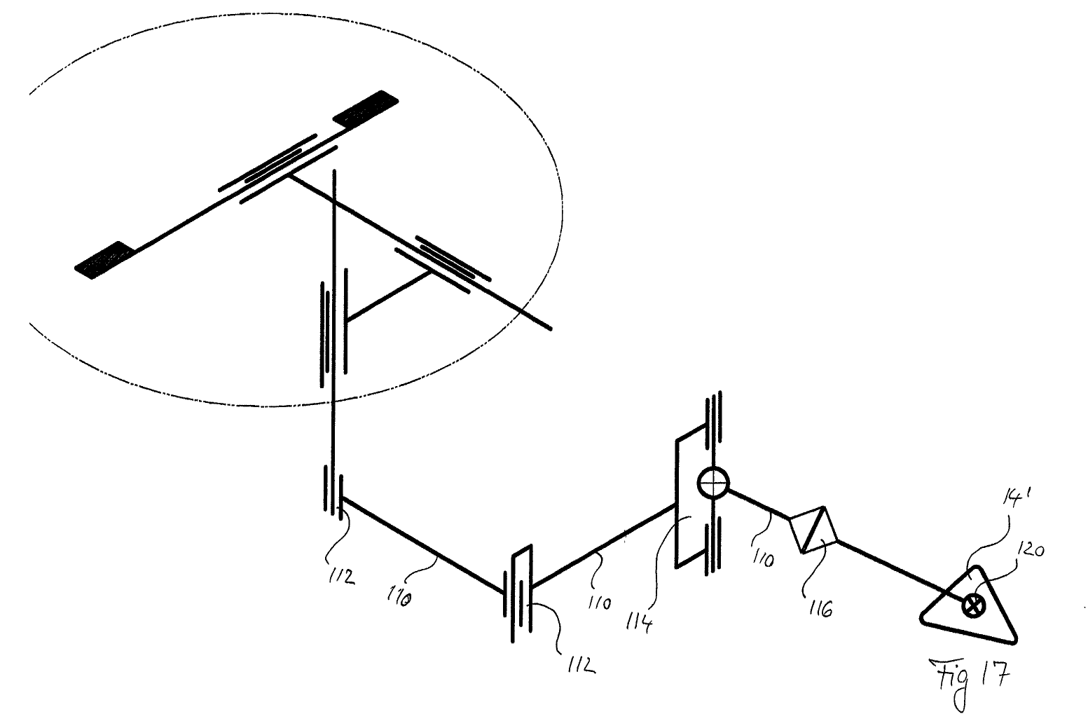

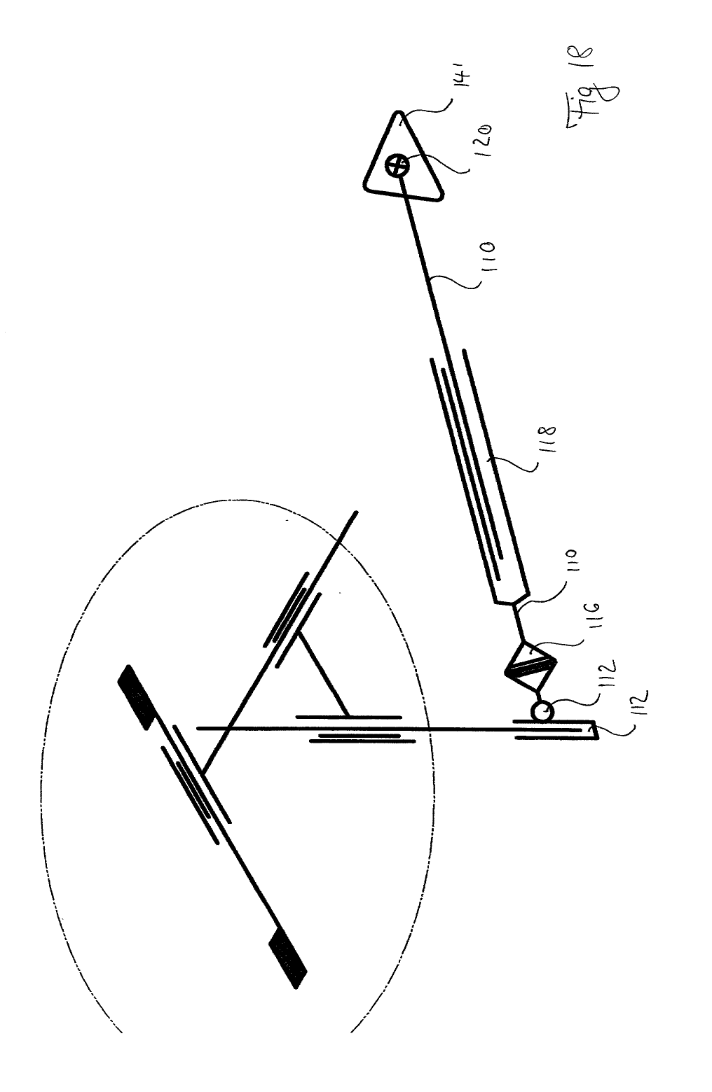

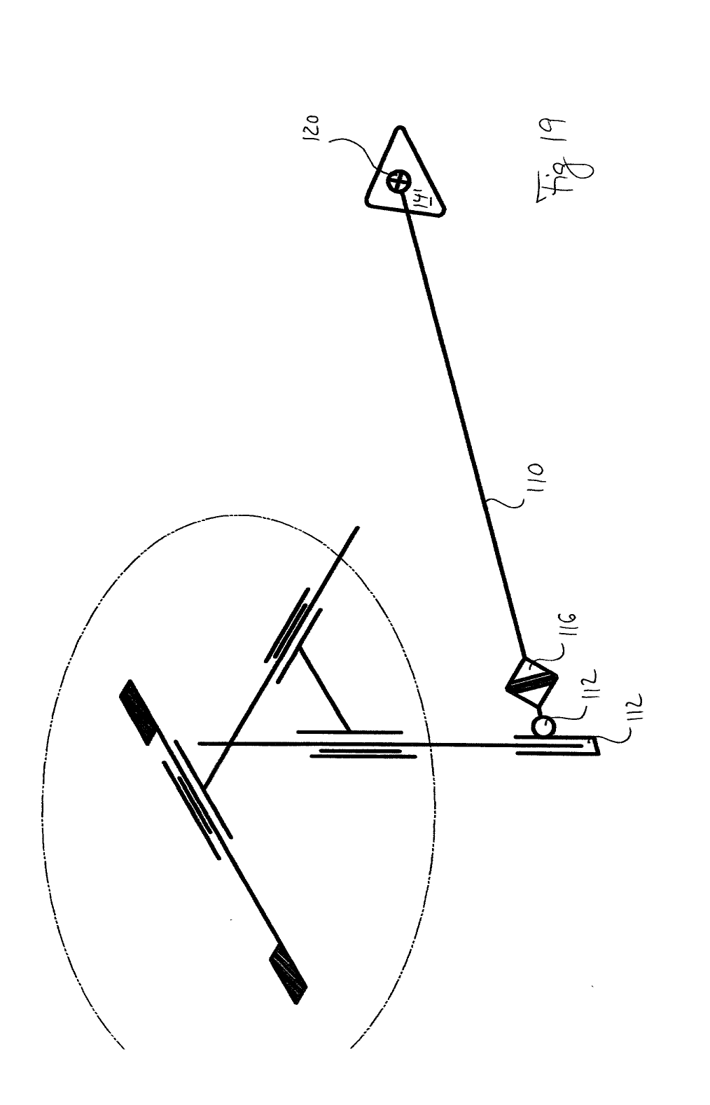

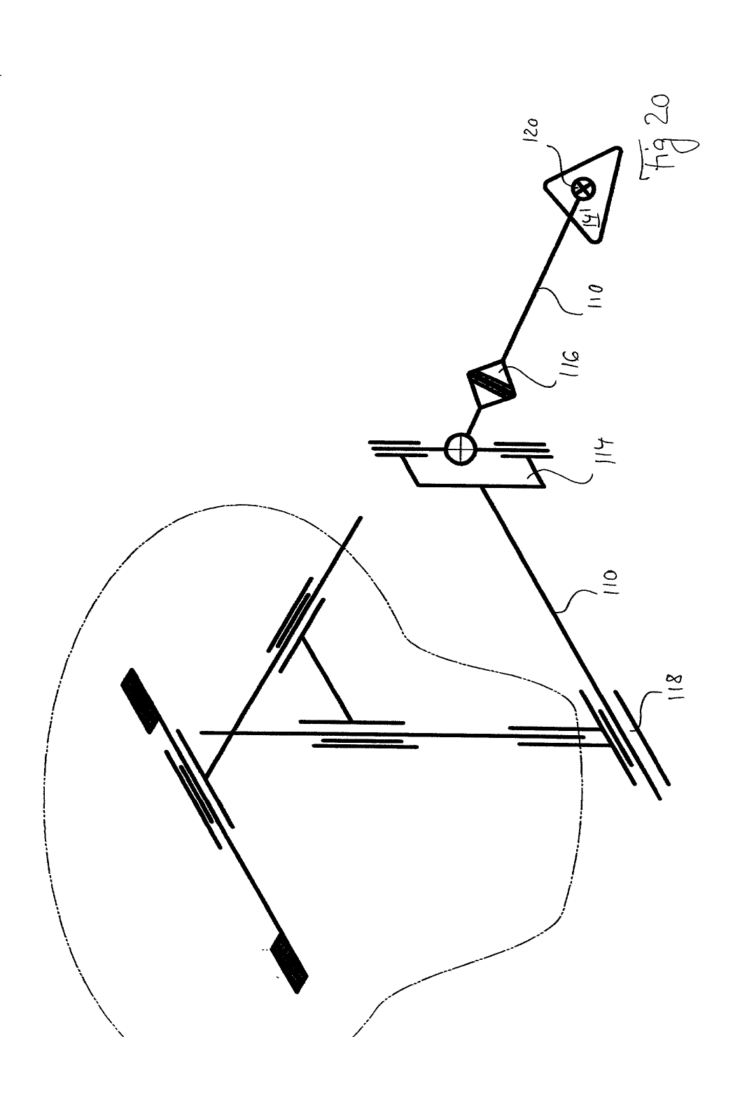

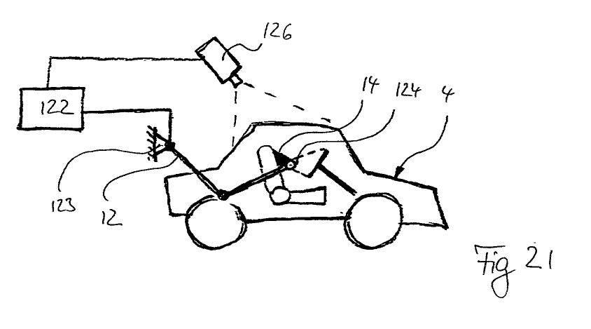

A cinematic model of the robot arm 12′ is shown in FIG. 16. Further cinematic models of alternative rendering of the robot arm are shown the FIGS. 17 to 20. The elements circled here with dots and dashes are similar to those already described to FIG. 2. The robot arms represented in FIGS. 17 to 20 are assembled from girder elements 110 and are combined with each other with a wisp tool 14′ by hinge 112, universal joints 114, axial knack cases 116, axial sliding sleeves 118 as well as Hooke's joints 120.

The cleaning tools 14, 14′ in accordance with FIG. 1-4 are interchangeably by means of a tool change-switch-mechanism 53 located under a port in the ground. Different tools for cleaning are represented in the FIGS. 5 to 13.

FIGS. 5 and 6 show a wisp tool 14′ with elastic, triangular wisp face 54 made in the kind of an micro fibre cloth, that is interchangeably attached by a kind of Velcro fastening 56 on the triangular elastic carrier 58. In the elastic basic body 58 a sucking-channel 60 runs along the edge of the triangular wisp face structure behind the micro fibre cloth 54. This channel 60 is connected to the connector 62 of a soft suction hose (not illustrated here) through which the dirt is led to the outside. A channel to spray cleaning liquid, such as pure water or soap like water is included in the connection 62, through which a cleaning liquid is pumped into a sucking-sponge 66, which is attached to the micro fibre cloth 54. This tool in accordance with FIG. 5 and 6 is to clean smooth surfaces, in particular, suitable for windows and panels on which for example also greasy dirt can be found. This type of dirt is best treated by a cleaning liquid, which will be sprayed onto the surface and sucked by a sucking-sponge 66.

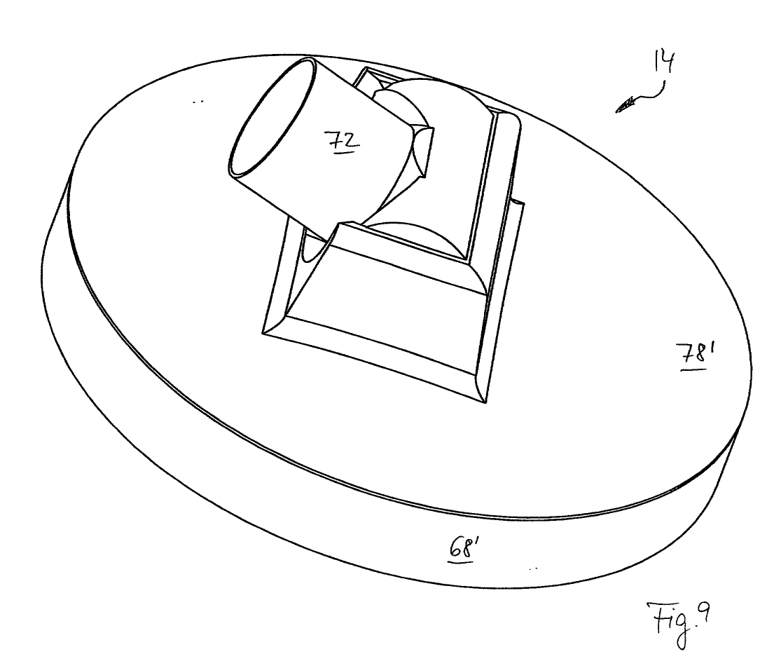

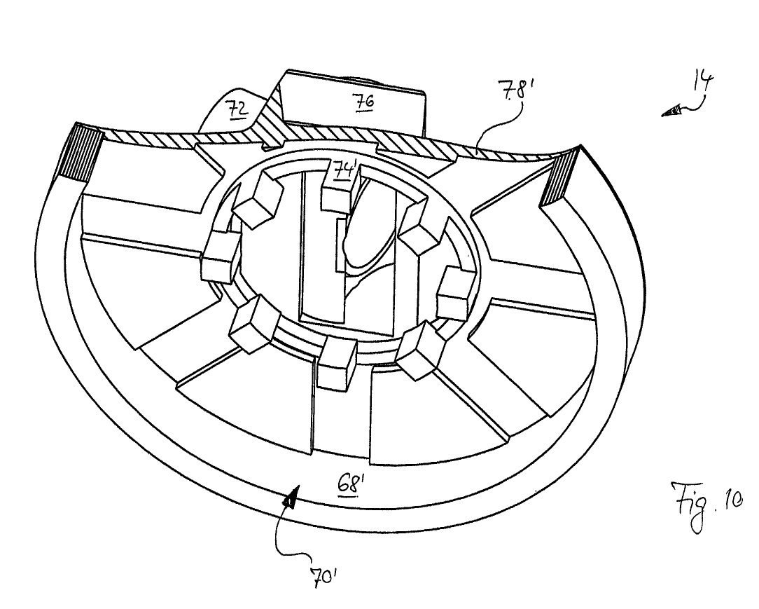

In FIGS. 7 and 8 a vacuum cleaner device with beating action 67 is illustrated, which has a brush like edge 68 around its sucking surface 70. Dirt will flow through the hose 72. To shake up the dirt from elastic cushions or also from the elastic wall panelling a knocking device 74 is integrated into the sucking-surface 70. In order to be able to process also non-flat surfaces the tool 67 has an elastic body 76 with elastic edge 78, that is surrounded by a brush edge 68 for maximally flush contact with a processed surface.

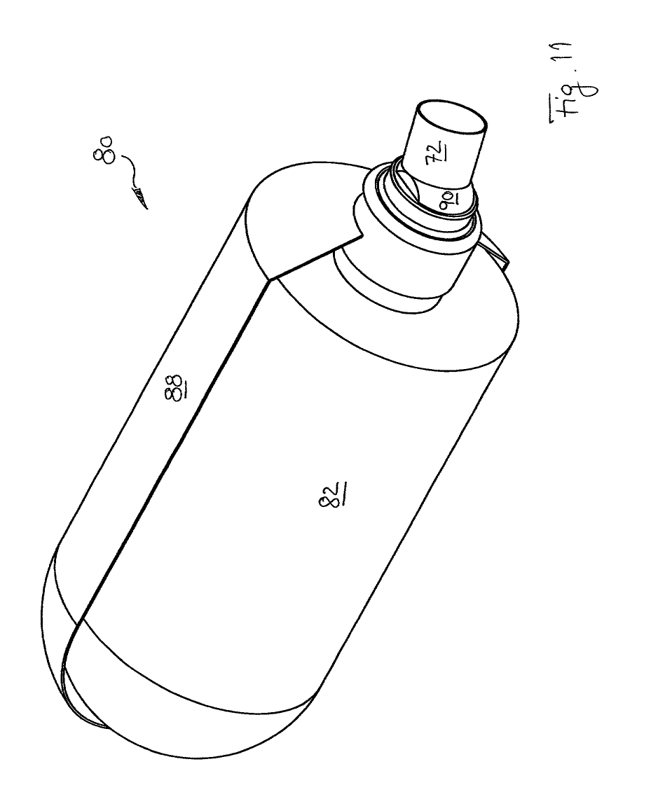

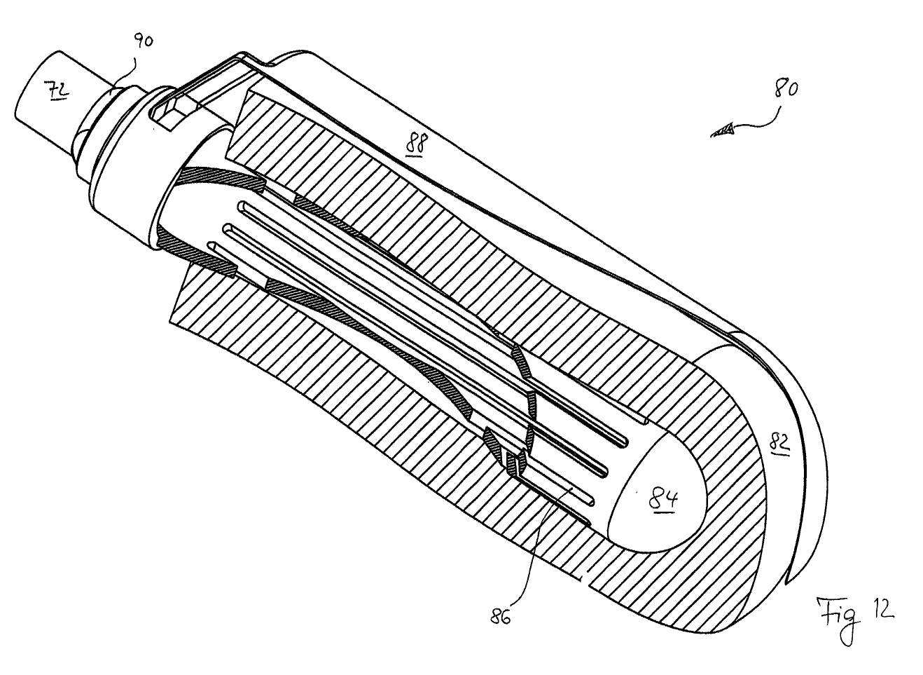

An alternative type of vacuum tool head with beating or knocking device 14 is shown in FIGS. 9 and 10. The cleaning tool 14 distinguishes from the tool 67 in accordance with FIG. 7 and 8 through its form: The tool 14 has a basically circular sucking-surface 70′ with brush edge 68′ at the edge 78′ of his basic body 76′. The beating device 74′ has a circular shape. However, also this tool 14 connects via a connecting piece 72 to the soft suction hose (not shown here).

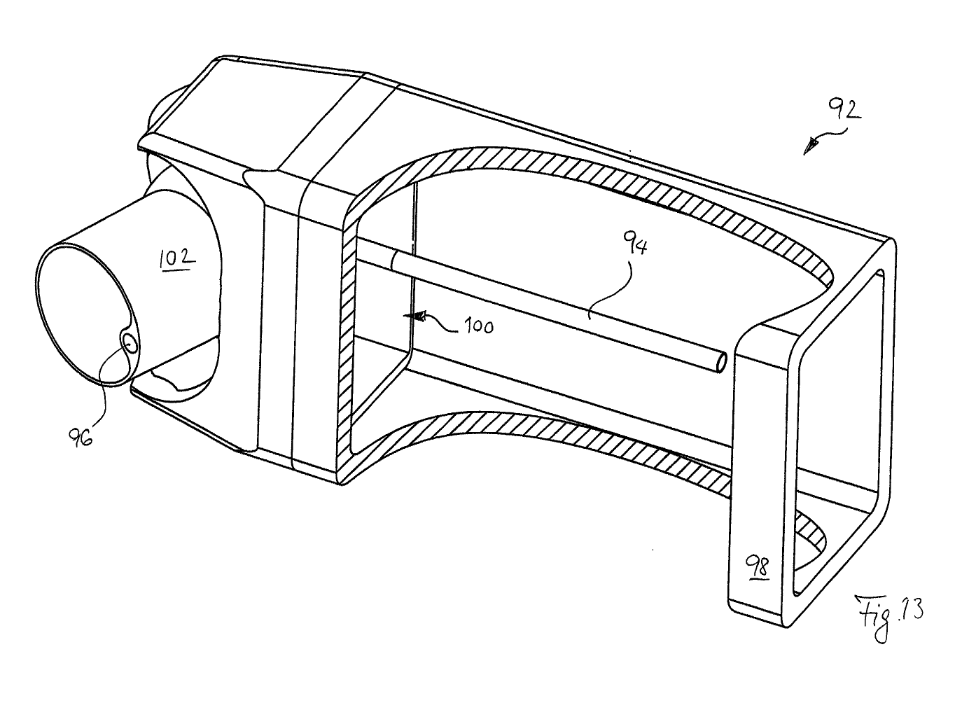

The sucking-tool 80 in accordance with FIG. 11 and 12 is equipped to beat-up the dirt particles with a rotating brush 82. The brush 82 mounted onto a rotating axes, which has sucking-slots 86 parallel to the axis. These slots connect to the suction hose via connecting piece 72. In order not to whirl dirt particles uncontrolled into the environment of the interior of the car one part of the rotating brush 82 is covered by a dust cover 88. The sucking-tool 80 is flexible mounted by means of a ball joint combination 90 to be moved into different directions.

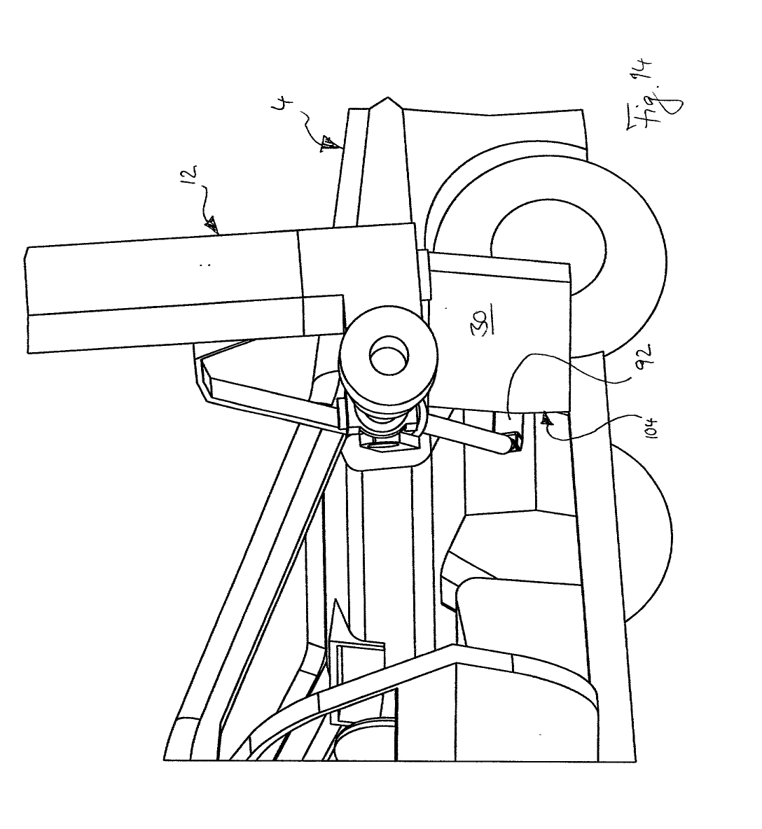

Finally another cleaning tool is illustrated in FIG. 13. This cleaning-tool 92 combines the process of blowing off dirt and sucking it and is in particular suitable to clean corners, into which for example the described sucking-tools 14, 14′, 67 and 80 do not reach. The blowing-sucking tool 92 has a blowing jet nozzle 94, that leads to a brush wreath 98 from a pressure pipe 96 and with bristles in same direction—surrounds this. Thus the dirt particle which where whirled up caused by the air stream, which is streaming out the blowing nozzle 94 are sucked off through sucking-cabinet 100.

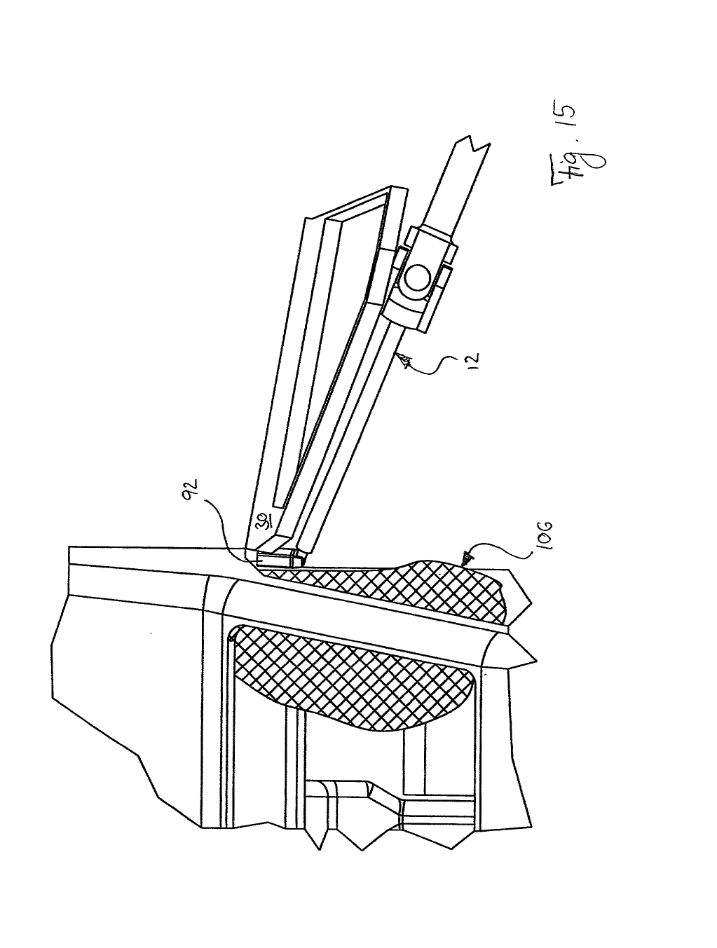

The blowing nozzle 94 of the tool 92 can alternatively also supply a wet vapour. In accordance with FIG. 14 this tool can then in particular also be used to clean the geometrical difficult car door fold 104, especially at the door joints. There might be special cleaning solutions for these oily car parts, which are pumped to these locations through soft suction hose 102.

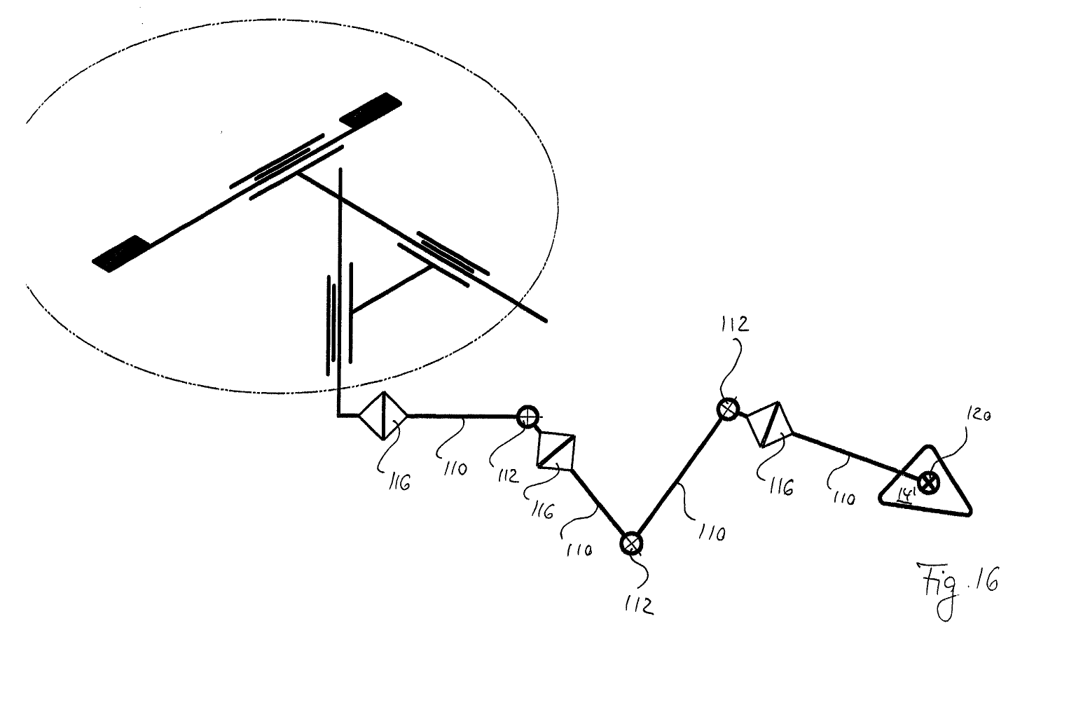

To protect the nearer environment of working tool 92 and to protect from dirt that still was not hold back through the brush edge 98, a flexible shielding 106 can be useful in accordance with FIG. 15. This shielding 106 is made of a flexible inflatable wrapper, for example made from epoxy rubber or latex that can be inflated in the door area of the interior—represented for example as in FIG. 15 as the door filling—, where dirt particles are most likely not to be whirled. The shielding 106 are made up from a compound of pneumatically combined chambers with inner carrying and supporting-elements (not shown in the FIG.). These elements guarantee an intrinsic stability of the shielding also in the uninflated state and allow a most extremely flexible adaptation to any shape in the inflated state. The exact positioning and supply (with compressed air) occurs with a separated kind of robot arm or can be done by the cleaning robot arm, not further shown here.

In FIG. 21 is illustrated that the motor driven robot arm 12 with the cleaning tool 14 is controlled from a programmable operation unit 122 that stands in electronic connection with at least one sensor 124, as well as with at least one camera 126. The software of the operation unit 122 will contain image recognition in order to define the car type and any changes of this. The sensors 124 and the cameras 126 characterize controlled with software the topography and the environment of the cleaning tool in order to recognize for example threatening collisions in time and to control the robot arm 12 correspondingly. The software can register the shape of the vehicle 4 before beginning of the cleaning program course so that the type and model of the vehicle 4 is recognize in order to control the movements of the robot arm 12 for the carrying out of the cleaning program.

1. A method to clean the interior of a car, by using appropriate cleaning appliances and moving these with at least one robot arm under the control of software and sensors as well as cameras in the interior of the car.

2. The method of claim 1, wherein the data of topography, geometry and type of car is stored in the system.

3. The method of claim 1, wherein the cleaning tools are interchanged throughout the cleaning process.

4. The method of claim 1, wherein the car stands still and the robot arm is moved in and around the car.

5. The method of claim 1, wherein the car is moved aside the robot arm from a starting to an ending position while the robot mechanism cleans the interior of the car.

6. The method of claim 1, wherein sucking cleaning tools are used to evacuate dirt.

7. The method of claim 1, wherein sucking cleaning tools are supported by beating tools, knocking on the surfaces to be cleaned to release the dirt of said surfaces.

8. The method of claim 1, wherein sucking cleaning tools are supported by brushes toughing and moving over the to be cleaned surfaces.

9. The method of claim 1, wherein sucking tools are supported by cleaning liquids sprayed onto the surfaces to be cleaned.

10. The method of claim 1, wherein wiping cloths are moved over the to be cleaned surfaces.

11. The method of claim 1, wherein wiping cloths are supported by sucking appliances.

12. The method of claim 1, wherein wet steam is used to elute the dirt from the to be cleaned surfaces.

13. The method of claim 1, wherein the soiling is collected and presented to the customer to remove any valuable belongings before being dumped.

14. The method of claim 1, wherein one cleaning zone is processed after the other and cleaning tools are interchanged as needed during the cleaning of one zone.

15. The method of claim 1, wherein one cleaning tool is used after the other in all cleaning zones before interchanged with other cleaning tools.

16. An apparatus to clean the interior of a car comprising at least one robot arm with multiple degrees of freedom to move, at least one interchangeable cleaning tool to adapted, at least one tough sensor, at least one digital camera and a data system with software to control the process.

17. The apparatus of claim 16, wherein the car is moved by motor means and guided by rails from a starting to an ending point.

18. The apparatus of claim 16, wherein the robot arm is hanging from the ceiling or at a wall or is standing on the floor.

19. The apparatus of claim 16, wherein the robot arm comprises multiple joints to gain multiple degrees of freedom for lateral and rotational movements.

20. The apparatus of claim 16, wherein the system comprises one device to hold open a car door.

21. The apparatus of claim 16, wherein the robot arm comprises a mechanism to interchange the cleaning tools.

22. The apparatus of claim 16, comprising a suction or vacuum mechanism.

22. The apparatus of claim 16, comprising an air blowing mechanism.

23. The apparatus of claim 16, comprising brushes as cleaning tools.

24. The apparatus of claim 16, comprising wiping tools.

25. The apparatus of claim 16, comprising suction tools.

26. The apparatus of claim 16 spraying tools to spray cleaning liquid.

27. The apparatus of claim 16, having a preparation and a rework area.
